(19) United States
(12) Patent Application Publication
(10) Pub. No.: US 2026/0246290 A1
(43) Pub. Date: Aug. 20, 2026

(54) ELECTRICAL COUPLING SYSTEM

(71) Applicant: Blixt Tech AB, Kista (SE)

(72) Inventor: Jan JOHANSSON, Solna (SE)

(73) Assignee: Blixt Tech AB, Kista (SE)

(21) Appl. No.: 19/160,812

(22) PCT Filed: Mar. 5, 2024
(86) PCT No.: PCT/SE2024/050203

§ 371 Date: Aug. 28, 2025

(30) Foreign Application Priority Data
Mar. 6, 2023 (SE) 2350251-1

(51) Int. Cl. H02J 7/82; H02J 7/00; H02J 7/34; H02J 7/60; H02J 7/90

(52) U.S. Cl. CPC H02J 7/82; H02J 7/34; H02J 7/663; H02J 7/855; H02J 7/933

(57) ABSTRACT

The invention relates to an electrical coupling system for electrically connecting a transmission port of a power source to a reception port of a power consumer, the electrical coupling circuit comprising a first electrical storage unit connected to the transmission port and the reception port, respectively, via a first mechanical switch, wherein the first mechanical switch is configured to operate in: a first mode in which the first electrical storage unit is in galvanic contact with the transmission port, a second mode in which the first electrical storage unit is in galvanic contact with the reception port, or a third mode in which the first electrical storage unit is in non-galvanic contact with the transmission port and in non-galvanic contact with the reception port. Furthermore, the invention also relates to an electrical system comprising a power source, a power consumer and an electrical coupling system.

### TECHNICAL FIELD

Embodiments of invention relate to an electrical coupling system for connecting a power source to a power consumer.

### BACKGROUND

Different types of electrical voltage systems or electrical power systems are known in the art. A power system may be configured to provide or feed an electrical load with electrical power. Such power systems may be denoted a power source, such as a wind power plant, a solar power plant, mains power grid, etc.

Power systems may also be configured to receive electrical power, i.e., to be fed by an external power source. Such power systems may be denoted a power consumer.

Power systems may also alternate between acting as a power source or a power consumer at different time instances. A battery system is an example of such a system.

When connecting a power source to a power consumer an electrical coupling arrangement is needed for transfer of the electrical power from the power source to the power consumer. The electrical coupling may be either based on non-galvanic contact e.g., by using transformers or based on direct conductive contact.

### SUMMARY

An objective of embodiments of the invention is to provide a solution which mitigates or solves the drawbacks and problems of conventional solutions.

An objective of embodiments of the invention is to provide a safe solution for transferring electrical power from a power source to a power consumer.

The above and further objectives are solved by the subject matter of the independent claims. Further embodiments of the invention can be found in the dependent claims.

According to a first aspect of the invention, the above mentioned and other objectives are achieved with an electrical coupling system for electrically connecting a transmission port of a power source to a reception port of a power consumer, the electrical coupling circuit comprising a first electrical storage unit connected to the transmission port and the reception port, respectively, via a first mechanical switch, wherein the first mechanical switch is configured to operate in:
a first mode in which the first electrical storage unit is in galvanic contact with the transmission port,
a second mode in which the first electrical storage unit is in galvanic contact with the reception port, or
a third mode in which the first electrical storage unit is in non-galvanic contact with the transmission port and in non-galvanic contact with the reception port.

The non-galvanic contact may also be understood a non-galvanic state. The first mechanical switch is thus in one of the first mode, the second mode or the third mode at a certain time instance.

Thus, the first electrical storage unit may be configured to load power from the power source when the first mechanical switch is in the first mode and delivery power to the power consumer when the first mechanical switch is in the second mode.

An advantage of the electrical coupling system herein disclosed is that safe galvanic isolation is provided between different power systems that may be interconnected to each other. Thus, personal safety is improved compared to conventional solutions. Further, the power transfer efficiency can also be improved since by using the disclosed electrical coupling system no transformers, inverters nor DC-DC converters with e.g., pulse width modulation (PWM) are needed thereby reducing power losses during power transfer.

In an implementation form of an electrical coupling system according to the first aspect, the first mechanical switch is configured to switch from the first mode to the second mode via the third mode, and vice versa.

In an implementation form of an electrical coupling system according to the first aspect, the first mechanical switch is configured to
switch to the first mode when a storage level of the first electrical storage unit is below a first threshold value; and/or
switch to the second mode when a storage level of the first electrical storage unit is over a second threshold value.

In an implementation form of an electrical coupling system according to the first aspect, the first threshold value is lower than the second threshold value.

In an implementation form of an electrical coupling system according to the first aspect, the first mechanical switch is configured to switch to the third mode when:
an error of the first electrical storage unit is detected;
a measurement of the first electrical storage unit is performed; and/or
the first electrical storage unit enters a passive mode.

Thereby, the electrical coupling system enters the third mode at relevant and critical events.

In an implementation form of an electrical coupling system according to the first aspect, the electrical coupling system comprises a first electrical switch connected between the first electrical storage unit and the first mechanical switch.

Thereby, the electrical safety may further be improved.

In an implementation form of an electrical coupling system according to the first aspect, the first electrical switch is configured to be in its non-conductive state when the first mechanical switch is switching to the first mode or the second mode.

Thereby, the electrical safety is further improved.

In an implementation form of an electrical coupling system according to the first aspect, the first electrical switch is configured to be in its conductive state when the first mechanical switch has switched to the first mode or the second mode.

Thereby, the electrical safety is further improved.

In an implementation form of an electrical coupling system according to the first aspect, the first electrical switch is configured to be in its non-conductive state when the first mechanical switch is in the third mode.

Thereby, power losses may be reduced.

In an implementation form of an electrical coupling system according to the first aspect, the electrical coupling system comprises:
a second electrical storage unit connected to the transmission port and the reception port, respectively, via a second mechanical switch; and
a third electrical storage unit connected to the transmission port and the reception port, respectively, via a third mechanical switch.

In an implementation form of an electrical coupling system according to the first aspect, the first mechanical switch is configured to operate in the first mode, the second mechanical switch is configured to operate in the second mode, and the third mechanical switch is configured to operate in the second mode, simultaneously at a first time instance.

Thereby, power delivery without power interruption is possible.

In an implementation form of an electrical coupling system according to the first aspect, the third mechanical switch is configured to switch to the first mode at a second time instance subsequent to the first time instance.

In an implementation form of an electrical coupling system according to the first aspect, the first mechanical switch is configured to switch to the second mode at a third time instance subsequent to the second time instance.

In an implementation form of an electrical coupling system according to the first aspect, the second mechanical switch is configured to switch to the first mode at a fourth time instance subsequent to the third time instance.

In an implementation form of an electrical coupling system according to the first aspect, the first mechanical switch is configured to operate in the first mode, the second mechanical switch is configured to operate in the second mode, and the third mechanical switch is configured to operate in the third mode, simultaneously at a first time instance.

Thereby, the electrical coupling system is prepared for a number of different applications.

In an implementation form of an electrical coupling system according to the first aspect, the third mechanical switch is configured to switch to the first mode or the second mode at a second time instance subsequent to the first time instance.

In an implementation form of an electrical coupling system according to the first aspect, the electrical coupling system comprises:
a second electrical switch connected between the second electrical storage unit and the second mechanical switch; and
a third electrical switch connected between the third electrical storage unit and the third mechanical switch.

In an implementation form of an electrical coupling system according to the first aspect, the electrical coupling system comprises a control device in communication with the mechanic switches and the electrical switches and being configured to control the mechanic switches and the electrical switches.

According to a second aspect of the invention, the above mentioned and other objectives are achieved with an electrical system comprising a power source, a power consumer and an electrical coupling system according to embodiments of the invention.

Further applications and advantages of embodiments of the invention will be apparent from the following detailed description.

### BRIEF DESCRIPTION OF THE DRAWINGS

The appended drawings are intended to clarify and explain different embodiments of the invention, in which:

FIG. 1 schematically illustrates an electrical coupling system according to an embodiment of the invention;

FIG. 2 shows the operation of a mechanical switch and an electrical switch according to embodiments of the invention;

FIG. 3 shows an electrical coupling system according to an embodiment of the invention;

FIGS. 4 and 5 illustrates further embodiments of the invention;

FIG. 6 shows an electrical coupling system according to embodiments of the invention; and

FIG. 7 illustrates an electrical power system.

### DETAILED DESCRIPTION

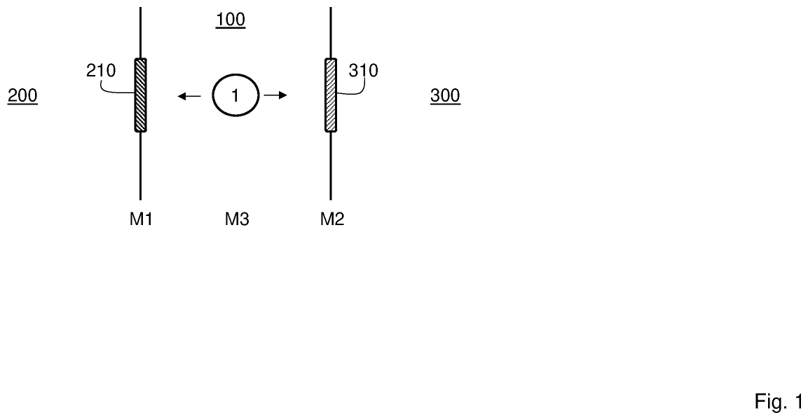

FIG. 1 illustrates an electrical coupling system 100 for electrically connecting a transmission port 210 of a power source 200 to a reception port 310 of a power consumer 300. The disclosed electrical coupling circuit 100 comprises a first electrical storage unit 1 connected to the transmission port 210 and the reception port 310, respectively, via a first mechanical switch 114.

The first mechanical switch 114 according to the invention is configured to operate in: a first mode M1 in which the first electrical storage unit 1 is in galvanic contact with the transmission port 210, a second mode M2 in which the first electrical storage unit 1 is in galvanic contact with the reception port 310, or a third mode M3 in which the first electrical storage unit 1 is in non-galvanic contact with the transmission port 210 and in non-galvanic contact with the reception port 310. Thus, the first electrical storage unit 1 may be in one of the three operating modes or states M1, M2, M3 at a certain time instance.

The transmission port 210 and the reception port 310 may be any suitable ports for conductively and electrically connecting the electrical coupling system 100 to the power source 200 and power consumer 300, respectively. Mentioned transmission port 210 and reception port 310 may each include one or more subports thereby be connected to a single or a plurality of power sources 200 and a single or a plurality of power consumers 300, respectively. The transmission port 210 and the reception port 310 may comprise conductive elements for direct conductive coupling. The electrical power at the power source 200 and power consumer 300 may be direct current (DC) or alternating current (AC). The input DC/AC and output DC/AC of the electrical coupling system 100 may have different voltages/currents and/or frequencies according to embodiments of the invention.

The power source 200 may be an electrical power source that feeds an electrical load(s) with electrical power and may be battery packs, wind power plants, solar power plants, grid power system or any other suitable power source. The power consumer 300 may be any electrical load(s) consuming electrical power directly or indirectly for its functioning such as electrical motors, electrical machines, etc. The power consumer 300 does however not have to consume power immediately. It may be noted that the power source 200 may switch between being configured to act as a power source and a power consumer at different time instances. The same applies for the power consumer 300 which may switch between being configured to act as a power consumer and a power source at different time instances.

Further, galvanic contact may herein mean direct electric conductive contact between conductive elements without any intermediate dielectric between the conductive elements. For example, a first conductive element in mechanic contact with a second conductive element may be considered as galvanic contact in this respect.

In embodiments of the invention, the first mechanical switch 114 is configured to switch from the first mode M1 to the second mode M2 via the third mode M3 which also holds for switching in the opposite direction. That is, the first mechanical switch 114 is also configured to switch from the second mode M2 to the first mode M1 via the third mode M3 according to this embodiment. Hence, the third mode M3 may be considered as an intermediate non-galvanic contact mode between the first mode M1 and the second mode M2 which both are galvanic contact modes.

In further embodiments of the invention, the first mechanical switch 114 may switch to the first mode M1 from the second mode M2 or the third mode M3 when a storage level of the first electrical storage unit 1 is below a first threshold value. Further, the first mechanical switch 114 may also switch to the second mode M2 from the first mode M1 or the third mode M3 when a storage level of the first electrical storage unit 1 is over a second threshold value. The first threshold value is lower than the second threshold value in embodiments of the invention. For example, the first threshold value may be 10% of the maximum power of the first electrical storage unit 1 and the second threshold value may be 90% of the maximum power of the first electrical storage unit 1. The first threshold value may be any other value of 20%, 30%, 40% and 50% while the second threshold value may be any other value of 80%, 70% and 60%.

Thus, the first electrical storage unit 1 would switch to the first mode M1 if a monitored power level gets below the first threshold value and correspondingly switch to the second mode M2 if the monitored power level raises above the second threshold value. Also, more than two threshold values may be used for controlling the operating mode/state of the first electrical storage unit 1. For example, one or more intermediate threshold values may be used such that the first electrical storage unit 1 switches to the third mode M3 if the power level passes such an intermediate threshold value. By proper determination of threshold values and coordination thereof, the electrical coupling system 100 may load electrical power and fed electrical power to fulfil requirements and conditions set by the power source 200 and the power consumer 300. Further, the lifetime of the first electrical storage unit 1 such as a battery may be optimized by such determination.

Moreover, the first mechanical switch 114 may switch to the third mode M3 from the first mode M1 or the second mode M2 when detecting an error/fault of the first electrical storage unit 1 so that the first electrical storage unit 1 may be removed or repaired. An error may mean that the functioning of the first electrical storage unit 1 is faulty or damaged. Other switching conditions for switching from the first mode M1 or the second mode M2 to the third mode M3 may include when measuring the first electrical storage unit 1, and/or entering a power saving mode or a passive mode of the first electrical storage unit 1. Measuring the first electrical storage unit 1 may be understood as performing any general measurements on the first electrical storage unit 1, such as measuring its power level or electrical characteristics e.g., its resistivity and conductivity. The power saving mode or passive mode may mean that the electrical storage unit 1 is totally disconnected to any external load(s) and thus the electrical power can be stored without almost any decline in its power level during a time period.

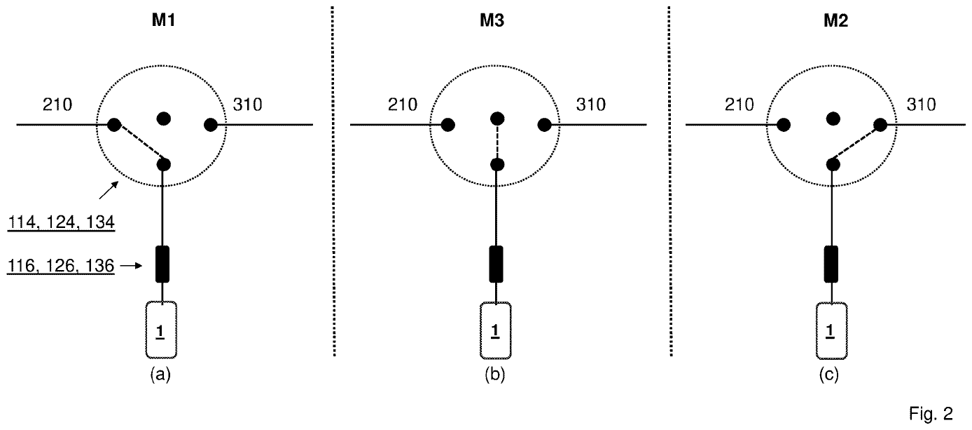

FIG. 2 shows more in detail how the mechanical switch 114 may operate according to the present solution. In FIG. 2a the first mechanical switch 114 operates in the first mode M1 and the first electrical storage unit 1 is therefore in galvanic contact with the transmission port 210 but not in galvanic contact with reception port 310. In FIG. 2c the first mechanical switch 114 is in the second mode M2 and the first electrical storage unit 1 is in galvanic contact with the reception port 310 but not in galvanic contact with the transmission port 210. Finally, in FIG. 2b the first mechanical switch 114 is in the third mode M3 and the first electrical storage unit 1 is not in galvanic contact with the reception port 310 and not in galvanic contact with the transmission port 210 and therefore not in galvanic contact with neither the power source 200 nor the power consumer 300. Thus, the first electrical storage unit 1 is in a conductive contact free mode when being in the third mode M3.

FIG. 2 also shows when the electrical coupling system 100 comprises a first electrical switch 116 that is associated and synchronized with the first mechanical switch 114 in operation. In this embodiment, the first electrical switch 116 is connected between the first electrical storage unit 1 and the first mechanical switch 114. Thus, the electrical power always has to pass through the first electrical switch 116 to and from the first electrical storage unit 1. The first electrical switch 116 may be of any suitable type such as a field effect transistor (FET) having a conductive state in which current can pass through the first electrical switch 116 and a non-conductive state in which no current can pass through the first electrical switch 116. Due to the present solution low voltage FETs may be used which are cheaper to produce compared to high voltage FETs.

In embodiments of the invention, the synchronization of the first mechanical switch 114 and the first electrical switch 116 among other things relates to the three different operating modes of the mechanical switch i.e., mode M1, M2 and M3. The first electrical switch 116 may switch from its conductive state to its non-conductive state prior to the first mechanical switch 114 is switching to the first mode M1. Thus, the first electrical switch 116 is configured to be in its non-conductive state when the first mechanical switch 114 is switching to the first mode M1 or the second mode M2. Further, the first electrical switch 116 may switch from its non-conductive state to its conductive state after the first mechanical switch 114 is switching to the second mode M2. Thus, the first electrical switch 116 is configured to be in its conductive state when the first mechanical switch 114 has switched to the first mode M1 or the second mode M2. Thereby, there is no current flow when the mechanical switch is switching which means that no electrical arc will be generated. For the third mode M3, the first electrical switch 116 may be in its non-conductive state when the first mechanical switch 114 is in the third mode M3 for power saving and measurements.

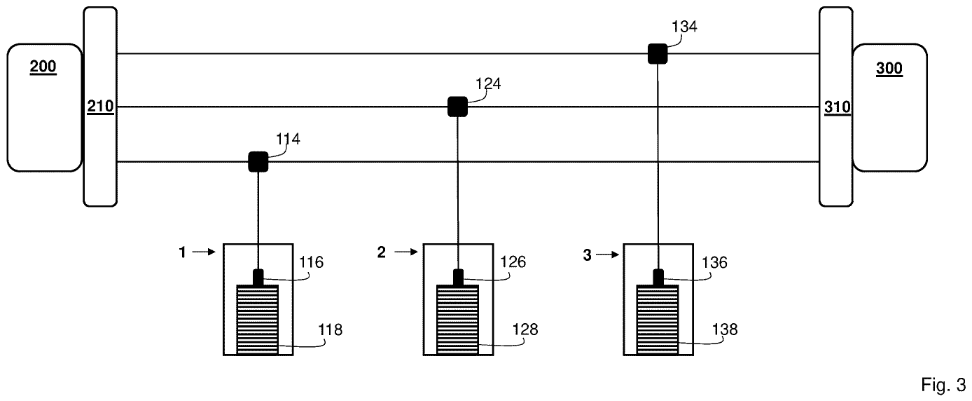

FIG. 3 shows an electrical coupling system 100 comprising addition electrical storage units. In the non-limiting disclosed example the electrical coupling system 100 comprises a second electrical storage unit 2 connected to the transmission port 210 and the reception port 310, respectively, via a second mechanical switch 124. The electrical coupling system 100 further comprises a third electrical storage unit 3 connected to the transmission port 210 and the reception port 310, respectively, via a third mechanical switch 134. It is however realized that the electrical coupling system 100 may comprise any number of electrical storage units being configured as the first electrical storage unit 1, i.e., being configured to work and operate according to any embodiments of the first electrical storage unit 1 such as in the first M1, second M2 and third M3 modes. The respective electrical storage units 1, 2, 3 are connected to the power source 200 and power consumer 300 via respective conductive lines and mechanical switches 114, 124, 134 and also additional electrical switches 116, 126, 136 in embodiments of the invention.

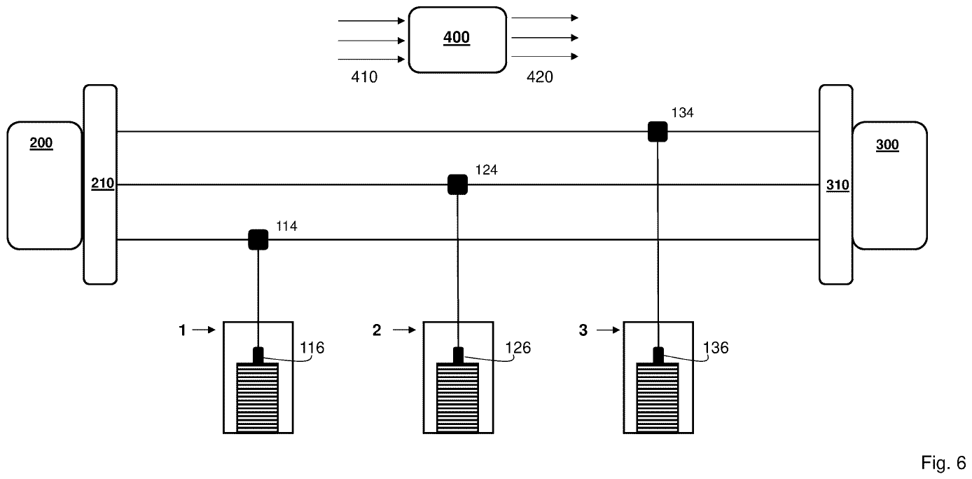

It may further be noted that each electrical storage unit 1, 2, 3 may include a set of electrical modules 118, 128, 138, such as batteries, capacitors and/or transformers, capable of storing electrical power. The set of electrical modules 118, 128, 138 inside an electrical storage unit 1, 2, 3 may be interconnected to each other via conductive interfaces and communication interfaces. The set of electrical modules 118, 128, 138 for each electrical storage unit 1, 2, 3 may be configured to provide different voltage values depending on a voltage configuration of the set of electrical modules 118, 128, 138. Mentioned voltage configuration may be controlled by a control device or control arrangement 400 e.g., via control lines as illustrated in FIG. 6.

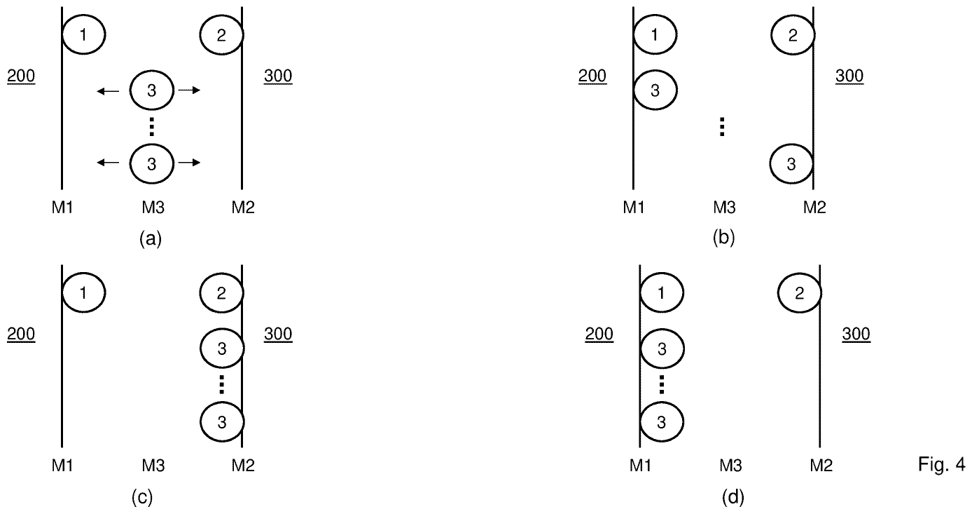

FIG. 4 illustrates possible operating configurations or states of the electrical storage units 1, 2, 3 of the electrical coupling system 100 herein disclosed. Generally, multiple electrical storage units may operate in any of the three modes M1, M2, M3 and may be synchronized with each other to provide different power coupling functions/settings depending on the required application. For example, as shown in FIG. 4a the first electrical storage unit 1 may be in the first mode M1 thereby loading electrical power from the power source 200 while the second electrical storage unit 2 may be in the second mode M2 thereby delivering electrical power to the power consumer 300. One or more third electrical storage units 3 may at the same be in the third intermediate mode M3 neither loading nor delivering electrical power. The third mode M3 could therefore also be denoted a resting mode or a passive mode or an energy saving mode or a measurement mode.

Depending on the desired power coupling function, the one or more third electrical storage units 3 may be configured to switch to the first mode M1 or the second M2. For example, FIG. 4b shows the case when some third electrical storage units have switched to the first mode M1 while some other third electrical storage units have switched to the second mode M2. This may for example happen when some third electrical storage units 3 need to load power while other third electrical storage units 3 have the capacity to deliver power which is needed by the power consumer 300. FIG. 4c on the other hand shows the case when all third electrical storage units 3 have switched to the second mode M2 while FIG. 4d shows the case when all third electrical storage units 3 instead have switched to the first mode M1. The example in FIG. 4c illustrates the case when all third electrical storage units 3 have the capacity to deliver power to the power consumer 300. The example in FIG. 4d on the other hand illustrates the case when all third electrical storage units 3 have to load power. Thus, the one or more third electrical storage units 3 may be configured to switch to the first mode M1 or the second M2 based on any of: a power level of a third electrical storage unit 3, a power capacity of the power source and a required power of the power consumer.

Thus, in embodiments of the invention the first mechanical switch 114 is configured to operate in the first mode M1, the second mechanical switch 124 is configured to operate in the second mode M2, and the third mechanical switch 134 is configured to operate in the third mode M3, simultaneously at a first time instance T1. Thereafter, the third mechanical switch 134 is configured to switch to the first mode M1 or the second mode M2 at a second time instance T2 subsequent to the first time instance T1. It may also be noted that electrical coupling system 100 may comprise a second electrical switch 126 connected between the second electrical storage unit 2 and the second mechanical switch 124; and a third electrical switch 136 connected between the third electrical storage unit 3 and the third mechanical switch 134.

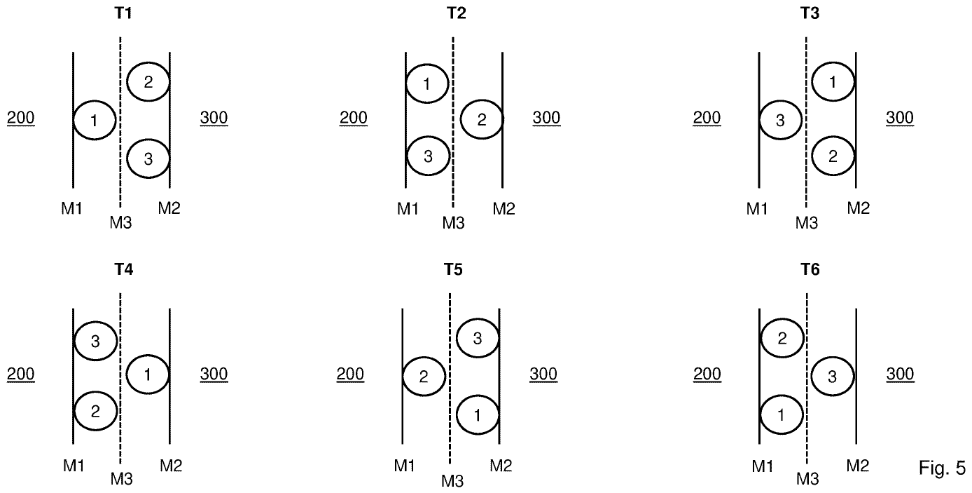

Moreover, FIG. 5 shows a sequential order of how the first 1, second 2 and third 3 electrical storage units may operate when the power coupling function is to provide power to the power consumer 300 without any power interruptions.

Thus, according to embodiments of the invention and with reference to FIG. 5, in an initial state the first mechanical switch 114 operates in the first mode M1, the second mechanical switch 124 in the second mode M2, and the third mechanical switch 134 operates in the second mode M2, simultaneously at a first time instance T1. This means that the first electrical storage unit 1 is in galvanic contact with the power source 200 while the second 2 and the third 3 electrical storage units are in galvanic contact with the power consumer 300 at the first time instance T1. Thereby, the first electrical storage unit 1 may load power when at least one of the second 2 and the third 3 electrical storage units feeds/delivers power to the power consumer 300.

At a second time instance T2 subsequent to and following the first time instance T1, the third mechanical switch 134 is configured to switch to the first mode M1. Thus, the third electrical storage unit 3 can load power from the power source 200 while the second electrical storage unit 2 feeds power to the power consumer 300.

At a third time instance T3 subsequent to the second time instance T2, the first mechanical switch 114 is configured to switch to the second mode M2. Thus, the first electrical storage unit 1 and/or the second electrical storage unit 2 can deliver power to the power consumer 300 at the same time.

At a fourth time instance T4 subsequent to the third time instance T3, the second mechanical switch 124 is configured to switch to the first mode M1. Thus, the second electrical storage unit 2 and the third electrical storage unit 3 can load power while the first electrical storage unit 1 still delivers power to the power consumer 300. By continuing to operate according to the disclosed examples of time instances T1, T2, T3, T4 the power consumer 300 is fed with power all the time without any power interruptions. Thus, galvanic isolation with uninterrupted power supply is made possible.

At the following time instances the electrical storage units 1, 2, 3 may switch/rotate into the different operating modes as illustrated for a time fifth instance T5 and a sixth instance T6 as also illustrated in FIG. 5. Other examples are possible to achieve different power coupling functions.

FIG. 6 illustrates an electrical coupling system 100 comprising a control device 400 in communication and connected to a set of mechanic switches 114, 124, 134 and a set of electrical switches 116, 126, 136 of the electrical coupling system 100. The mechanic switches and the electrical switches may be connected to the control device 400 via suitable input 410 and output 420 control lines, control interfaces or communication interfaces. The control device 400 may control the set of mechanic switches 114, 124, 134 and the set of electrical switches 116, 126, 136 via wired, wireless or combined wired and wireless control means.

In embodiments of the invention, the control device 400 is configured to control the set of mechanical switches 114, 124, 134 and the set of electrical switches 116, 126, 136 via the input control lines 410 and the output control lines 420. The control device 400 may also obtain power source data/information from the power source 200 and power consumer data/information from the power consumer 300 and to control the operating modes of the mechanical switches and the electrical switches based on power source information and/or power consumer information and/or information about the individual electrical storage units of the electrical coupling system 100. The control device 400 may comprise any logic, processor, memory, communication interface, and/or software for controlling the parts, components and units of the herein disclosed electrical coupling system 100.

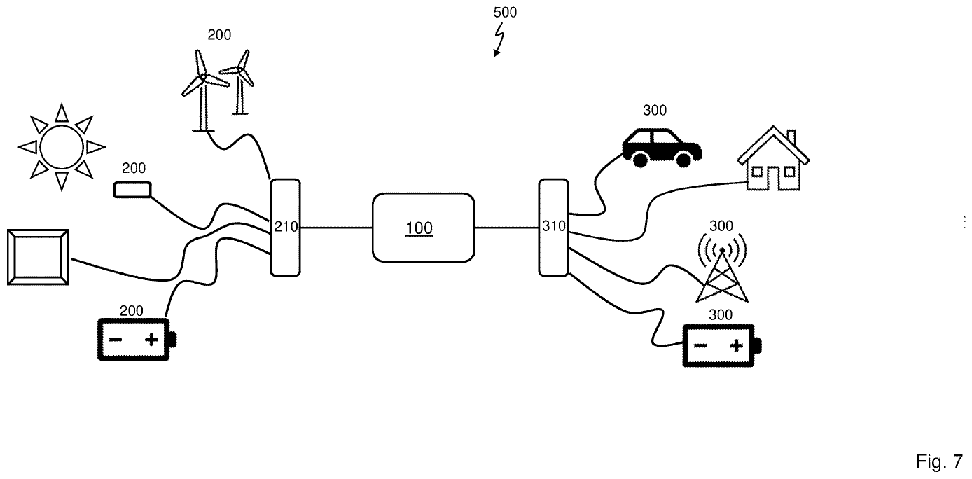

FIG. 7 shows an electrical system 500 comprising at least one power source 200, at least one power consumer 300 and at least one electrical coupling system 100 according to embodiments of the invention. The electrical coupling system 100 is electrically connected between a transmission port 210 and a reception port 310. Exemplary power sources are wind plants, solar power plants, power grid, batteries, etc. Exemplary power consumers are cars, trucks and base stations, batteries, electrical systems of buildings, etc.

Finally, it should be understood that the invention is not limited to the embodiments described above, but also relates to and incorporates all embodiments within the scope of the appended independent claims.

1. An electrical coupling system for electrically connecting a transmission port of a power source to a reception port of a power consumer, the electrical coupling circuit comprising a first electrical storage unit connected to the transmission port and the reception port, respectively, via a first mechanical switch, wherein the first mechanical switch is configured to operate in:
a first mode in which the first electrical storage unit is in galvanic contact with the transmission port,
a second mode in which the first electrical storage unit is in galvanic contact with the reception port, or
a third mode in which the first electrical storage unit is in non-galvanic contact with the transmission port and in non-galvanic contact with the reception port.

2. The electrical coupling system according to claim 1, wherein the first mechanical switch is configured to switch from the first mode to the second mode via the third mode, and vice versa.

3. The electrical coupling system according to claim 1, or wherein the first mechanical switch is configured to
switch to the first mode when a storage level of the first electrical storage unit is below a first threshold value; and/or
switch to the second mode when a storage level of the first electrical storage unit is over a second threshold value.

4. The electrical coupling system according to claim 3, wherein the first threshold value is lower than the second threshold value.

5. The electrical coupling system according to claim 1, wherein the first mechanical switch is configured to switch to the third mode when:
an error of the first electrical storage unit is detected;
a measurement of the first electrical storage unit is performed; and/or
the first electrical storage unit enters a passive mode.

6. The electrical coupling system according to claim 1, comprising a first electrical switch connected between the first electrical storage unit and the first mechanical switch.

7. The electrical coupling system according to claim 6, wherein the first electrical switch is configured to be in its non-conductive state when the first mechanical switch is switching to the first mode or the second mode.

8. The electrical coupling system according to claim 7, wherein the first electrical switch is configured to be in its conductive state when the first mechanical switch has switched to the first mode or the second mode.

9. The electrical coupling system according to claim 6, wherein the first electrical switch is configured to be in its non-conductive state when the first mechanical switch is in the third mode.

10. The electrical coupling system according to claim 1, comprising:
a second electrical storage unit connected to the transmission port and the reception port, respectively, via a second mechanical switch; and
a third electrical storage unit connected to the transmission port and the reception port, respectively, via a third mechanical switch.

11. The electrical coupling system according to claim 10, wherein the first mechanical switch is configured to operate in the first mode the second mechanical switch is configured to operate in the second mode, and the third mechanical switch is configured to operate in the second mode, simultaneously at a first time instance.

12. The electrical coupling system according to claim 11, wherein the third mechanical switch is configured to switch to the first mode at a second time instance subsequent to the first time instance.

13. The electrical coupling system according to claim 12, wherein the first mechanical switch is configured to switch to the second mode at a third time instance subsequent to the second time instance.

14. The electrical coupling system according to claim 13, wherein the second mechanical switch is configured to switch to the first mode at a fourth time instance subsequent to the third time instance.

15. The electrical coupling system according to claim 10, wherein the first mechanical switch is configured to operate in the first mode, the second mechanical switch is configured to operate in the second mode, and the third mechanical switch is configured to operate in the third mode, simultaneously at a first time instance.

16. The electrical coupling system according to claim 15, wherein the third mechanical switch is configured to switch to the first mode or the second mode at a second time instance subsequent to the first time instance.

17. The electrical coupling system according to claim 10, comprising
a second electrical switch connected between the second electrical storage unit and the second mechanical switch; and
a third electrical switch connected between the third electrical storage unit and the third mechanical switch.

18. The electrical coupling system according to claim 1, comprising a control device in communication with the mechanic switches and the electrical switches and being configured to control the mechanic switches and the electrical switches.

19. An electrical system comprising: a power source, a power consumer and an electrical coupling system according to claim 1.
